(19) United States
(12) Patent Application Publication
(10) Pub. No.: US 2025/0092172 A1
(43) Pub. Date: Mar. 20, 2025

(54) METHACRYLIC RESIN, METHOD FOR PRODUCING SAME, RESIN COMPOSITION AND RESIN FILM

(71) Applicant: KANEKA CORPORATION, Osaka (JP)

(72) Inventors: Takefumi Furuta, Osaka (JP); Yoshio Furukawa, Osaka (JP)

(73) Assignee: KANEKA CORPORATION, Osaka (JP)

(21) Appl. No.: 18/966,567

(22) Filed: Dec. 3, 2024

Related U.S. Application Data
(63) Continuation of application No. PCT/JP2023/021125, filed on Jun. 7, 2023.

(30) Foreign Application Priority Data
Jun. 7, 2022 (JP) 2022-092343

(51) Int. Cl. C08F 120/14; C08J 5/18; G02B 1/14; G02B 5/30

(52) U.S. Cl. CPC C08F 120/14; C08J 5/18; G02B 1/14; C08J 2333/12; G02B 5/3025

(57) ABSTRACT

A methacrylic resin includes structural units derived from methyl methacrylate at a ratio of 98% by mass or more, has a triad syndiotacticity of 55% or more, and contains a terminal structure that is derived from a polymerization initiator and is represented by formula (1). The ratio of terminal double bonds to the structural units derived from methyl methacrylate is less than 0.020 mol %. A method for producing the methacrylic resin is provided. In formula (1), each of R¹, R² and R³ independently represents an alkyl group, a substituted alkyl group, an ester group or an amide group, provided that at least one of R¹, R² and R³ represents an ester group or an amide group.

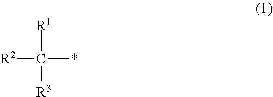

### TECHNICAL FIELD

One or more embodiments of the present invention relate to a methacrylic resin and a method for producing the same, a resin composition, and a resin film.

### BACKGROUND

Methacrylic resins are widely used in various fields because they have excellent transparency, weather resistance, processability, and the like. In particular, a resin film obtained by molding a methacrylic resin is also used in optical applications such as display devices because of its excellent optical properties. The methacrylic resin is produced, for example, by polymerizing a monomer mixture containing methyl methacrylate as a main component in the presence of a polymerization initiator and a chain transfer agent (see, for example, Patent Document 1).

### Patent Document

Patent Document 1: PCT International Publication No. WO2019/088025

However, as a result of investigation by the present inventor, it was found that depending on conditions such as the type of polymerization initiator used in the synthesis of a methacrylic resin, thermal stability of the methacrylic resin obtained decreases.

### SUMMARY

One or more embodiments of the present invention are to provide a methacrylic resin excellent in thermal stability and a method for producing the same, a resin composition containing the methacrylic resin, a resin film containing the methacrylic resin, and a polarizing plate and a display device including the resin film.

The above includes the following embodiments.

<1> A methacrylic resin including a structural unit derived from methyl methacrylate in a proportion of 98% by mass or more, in which
the methacrylic resin has a triad syndiotacticity of 55% or more,
the methacrylic resin comprises a terminal structure that is derived from a polymerization initiator and that is represented by the following formula (1), and
a proportion of terminal double bonds to the structural unit derived from methyl methacrylate is less than 0.020 mol %,

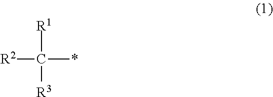

in the formula, R¹, R², and R³ each independently represent an alkyl group, a substituted alkyl group, an ester group, or an amide group, provided that at least one of R¹, R², or R³ represents an ester group or an amide group, two of R¹, R², or R³ may be bonded to each other to form an alicyclic structure, and * represents a bond to a structural unit derived from a monomer.

<2> The methacrylic resin as described in <1>, in which thermogravimetric reduction ratio when exposed to 280° C. for 15 minutes in a nitrogen gas atmosphere is less than 2.5%.

<3> The methacrylic resin as described in <1> or <2>, in which the terminal structure represented by the formula (1) is a terminal structure derived from at least one selected from dimethyl 2,2′-azobis(isobutyrate) or dimethyl 1,1′-azobis(1-cyclohexanecarboxylate).

<4> The methacrylic resin as described in any one of <1> to <3>, in which the methacrylic resin has a weight average molecular weight (Mw) measured by gel permeation chromatography (GPC) of 50,000 to 200,000.

<5> The methacrylic resin as described in any one of <1> to <4>, in which the methacrylic resin has a ratio (Mw/Mn) of a weight average molecular weight (Mw) to a number average molecular weight (Mn) measured by gel permeation chromatography (GPC) of 1.6 to 2.5.

<6> A method for producing a methacrylic resin, including:
a polymerization step of polymerizing a monomer mixture having a methyl methacrylate content of 98% by mass or more at 100° C. or less in the presence of a non-nitrile azo polymerization initiator and a chain transfer agent until a polymerization conversion ratio reaches 90% or more,
in which an amount of the chain transfer agent to be used is 0.10 mol % or more with respect to a total amount of the monomer mixture, and
a ratio of a total molar amount of the chain transfer agent to a total molar amount of the non-nitrile azo polymerization initiator is 2.0 or more.

<7> The method for producing a methacrylic resin as described in <6>, in which aqueous polymerization is performed in the polymerization step.

<8> The method for producing a methacrylic resin as described in <6> or <7>, in which the non-nitrile azo polymerization initiator includes at least one selected from dimethyl 2,2′-azobis(isobutyrate) or dimethyl 1,1′-azobis(1-cyclohexanecarboxylate).

<9> A resin composition including the methacrylic resin as described in any one of <1> to <5>.

<10> The resin composition as described in <9>, including an ultraviolet absorber.

<11> A resin film including the methacrylic resin as described in any one of <1> to <5>.

<12><11> The resin film as described in <11>, including an ultraviolet absorber.

<13> The resin film as described in <11> or <12>, in which the resin film is a polarizer protective film.

<14> A polarizing plate formed by laminating a polarizer and the resin film as described in any one of <11> to <13>.

<15> A display device including the polarizing plate as described in <14>.

According to one or more embodiments of the present invention, it is possible to provide a methacrylic resin excellent in thermal stability and a method for producing the same, a resin composition containing the methacrylic resin, a resin film containing the methacrylic resin, and a polarizing plate and a display device using the resin film.

### DETAILED DESCRIPTION

Hereinafter, one or more embodiments of the present invention will be described in detail. The symbol “-” representing a numerical range is used to include the lower limit and the upper limit of the range, unless otherwise specified.

### <Methacrylic Resin>

In the methacrylic resin according to one or more embodiments, a proportion of a structural unit derived from methyl methacrylate is 98% by mass or more, and a proportion of a structural unit derived from a monomer other than methyl methacrylate is 2% by mass or less. In the methacrylic resin according to one or more embodiments, the proportion of a structural unit derived from methyl methacrylate is 99% by mass or more, or 100% by mass (that is, the methacrylic resin is a homopolymer of methyl methacrylate). Note that the structural unit derived from methyl methacrylate is represented by the following formula.

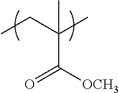

Examples of monomers other than methyl methacrylate include alkyl esters of acrylic acid such as methyl acrylate, ethyl acrylate, propyl acrylate, butyl acrylate, 2-ethylhexyl acrylate, etc.; aryl esters of acrylic acid, such as phenyl acrylate; cycloalkyl esters of acrylic acid, such as cyclohexyl acrylate, norbornenyl acrylate, etc.; alkyl esters of methacrylic acid other than methyl methacrylate, such as ethyl methacrylate, propyl methacrylate, butyl methacrylate, etc.; aryl esters of methacrylic acid such as phenyl methacrylate; cycloalkyl esters of methacrylate such as cyclohexyl methacrylate, norbornenyl methacrylate, etc.; aromatic vinyl compounds such as styrene, α-methylstyrene, etc.; acrylamides; methacrylamides; acrylonitrile; methacrylonitrile; and the like.

The methacrylic resin according to one or more embodiments has a triad syndiotacticity (rr) of 55% or more, 56% or more, or 57% or more. When the triad syndiotacticity (rr) is 55% or more, glass transition temperature (Tg) of the methacrylic resin becomes high, and the heat resistance tends to be improved. The upper limit of the syndiotacticity (rr) is not particularly limited, but may be 67% or less, 65% or less, or 63% or less from the viewpoints of molding temperature and toughness and secondary workability of a molded article.

The syndiotacticity (rr) refers to a percentage that two successive chains (diad) possessed by a chain (triad) composed of three successive structural units are both racemo (rr). Note that, in a chain (diad) of structural units in a polymer molecule, a diad having the same steric configuration is referred to as meso, and a diad having reversed steric configurations is referred to as racemo, the meso and the raceme being denoted by m and r, respectively.

As described in Examples below, the syndiotacticity (rr) can be calculated using formula: (X/Y)×100, where X and Y are an area (X) of a region of 0.60 to 0.95 ppm and an area (Y) of a region of 0.60 to 1.25 ppm, respectively, provided that X and Y are measured from a ¹H-NMR spectrum measured in deuterated chloroform at 22° C. for 16 integrations, when tetramethylsilane (TMS) is assigned as 0 ppm.

The methacrylic resin according to one or more embodiments has a glass transition temperature (Tg) of 120° C. or higher, 121° C. or higher, or 122° C. or higher. The upper limit of the glass transition temperature (Tg) is not particularly limited, but may be 135° C. or less, and may be 130° C. or less from the viewpoints of molding temperature and secondary workability of the molded article.

In the present specification, the glass transition temperature (Tg) is a midpoint glass transition temperature determined from a DSC curve, and is measured by the method described in Examples described below.

The syndiotacticity (rr) and glass transition temperature (Tg) of a methacrylic resin can be controlled by adjusting a polymerization temperature when synthesizing the methacrylic resin. For example, lowering the polymerization temperature is preferable in increasing the syndiotacticity (rr) of the methacrylic resin and increasing the glass transition temperature (Tg). The glass transition temperature (Tg) can also be controlled by adjusting the molecular weight of the methacrylic resin.

The methacrylic resin according to one or more embodiments includes a terminal structure represented by the following formula (1), the structure being derived from a polymerization initiator:

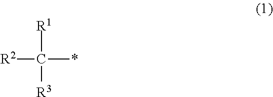

In the formula, R¹, R², and R³ each independently represent an alkyl group, a substituted alkyl group, an ester group, or an amide group; however, at least one of R¹, R², or R³ represents an ester group or an amide group; two of R¹, R², and R³ may be bonded to each other to form an alicyclic structure; and * represents a bond to a structural unit derived from the monomer.

Examples of the alkyl group include a linear or branched alkyl group having 1 to 6 carbon atoms. Examples of the substituent that the alkyl group may have include a hydroxy group, a carboxy group, an alkoxy group, a halogen atom, etc.

Examples of the ester group include a group represented by —COOR⁴. R⁴ represents an alkyl group having 1 to 6 carbon atoms, and may have a substituent such as a hydroxy group, a carboxy group, an alkoxy group, a halogen atom, or the like.

Examples of the amide group include a group represented by —C(O)NR⁵. R⁵ represents an alkyl group having 1 to 6 carbon atoms, a cycloalkyl group, or an alkenyl group having 2 to 6 carbon atoms, and may have a substituent such as a hydroxy group, a carboxy group, an alkoxy group, a halogen atom, or the like.

The terminal structure represented by the above formula (1) can be introduced into the molecule of the methacrylic resin by using a non-nitrile azo polymerization initiator represented by the following formula (2) when synthesizing the methacrylic resin. In the formula, R¹, R², and R³ are as defined in the above formula (1). Use of such a non-nitrile azo polymerization initiator tends to improve the thermal stability of the methacrylic resin obtained as compared with a case of using a polymerization initiator other than the non-nitrile azo polymerization initiator (for example, a nitrile azo polymerization initiator). In addition, the non-nitrile azo polymerization initiator is preferable in that the toxicity of the initiator itself and/or decomposition products tends to be lower than that of the nitrile azo polymerization initiator.

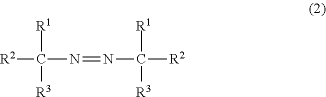

Examples of the non-nitrile azo polymerization initiator represented by the above formula (2) include dimethyl 2,2′-azobis(isobutyrate), dimethyl 1,1′-azobis(1-cyclohexanecarboxylate), 2,2′-azobis [N-(2-propenyl)-2-methylpropionamide], 2,2′-azobis(N-butyl-2-methylpropionamide), 2,2′-azobis(N-cyclohexyl-2-methylpropionamide), 2,2′-azobis{2-methyl-N-[2-(1-hydroxyethyl)]propionamide}, 2,2′-azobis{2-methyl-N-[2-(1-hydroxybutyl)]propionamide}, etc. Among these, at least one selected from dimethyl 2,2′-azobis(isobutyrate) or dimethyl 1,1′-azobis(1-cyclohexanecarboxylate) is preferable from the viewpoints of half-life temperature, cost, and the like.

In the methacrylic resin according to one or more embodiments, a proportion of terminal double bonds to the structural unit derived from methyl methacrylate is less than 0.020 mol %, less than 0.015 mol %, less than 0.010 mol %, or less than 0.006 mol %. When the proportion of terminal double bonds is within the above range, the thermal stability of the methacrylic resin tends to be improved.

The methacrylic resin according to one or more embodiments can be produced by a radical polymerization method as shown in the production method described later. The methacrylic resin produced by the radical polymerization method contains a terminal double bond generated by a disproportionation termination reaction during polymerization, a hydrogen abstraction reaction of a monomer by a polymerization initiator, or the like. Since the terminal double bond affects the thermal stability of the resin, a proportion thereof may be small. The proportion of terminal double bonds is controlled by the method described below, and if the ratio can be reduced to a range of 0.001 mol % or more and less than 0.020 mol %, the thermal stability of the methacrylic resin tends to be significantly improved.

The proportion of terminal double bonds to the structural unit derived from methyl methacrylate can be determined by, as described in Examples below, measuring a ¹H-NMR spectrum in deuterated chloroform at 20° C. for an integration number of 8,192 times; measuring a total area (X) of peaks (5.47 to 5.53 ppm and 6.21 ppm) derived from the terminal double bond portion of the methacrylic resin and an area (Y) of peaks (0.5 to 1.25 ppm) derived from an α-methyl group of the methacrylic resin from the spectrum; and calculating the ratio using the formula: [(3×X)/(2×Y)]×100.

The proportion of terminal double bonds of the methacrylic resin can be controlled by adjusting amounts of the polymerization initiator and the chain transfer agent to be used in synthesizing the methacrylic resin, the polymerization temperature, the polymerization time, and the like. For example, it is preferable to reduce the amount of the polymerization initiator to be used, to increase the amount of the chain transfer agent to be used, to lower the polymerization temperature, and to increase the polymerization time in order to reduce the proportion of terminal double bonds.

As described above, the methacrylic resin according to one or more embodiments has excellent thermal stability. The methacrylic resin according to one or more embodiments has a thermogravimetric reduction ratio of less than 2.5%, or less than 2.3% when exposed to 280° C. for 15 minutes in a nitrogen gas atmosphere. This thermogravimetric reduction ratio can be measured by the method described in Examples below.

The methacrylic resin according to one or more embodiments has a weight average molecular weight (Mw) of 50,000 to 200,000, or 90,000 to 150,000. When the weight average molecular weight (Mw) of the methacrylic resin is 50,000 or more, the mechanical properties of the molded article obtained tend to be improved, and when the weight average molecular weight (Mw) of the methacrylic resin is 200,000 or less, moldability tends to be improved.

The methacrylic resin according to one or more embodiments has a dispersity (Mw/Mn), i.e., ratio of the weight average molecular weight (Mw) to the number average molecular weight (Mn), of 1.6 to 2.5, or 1.7 to 2.2. When the dispersity (Mw/Mn) of the methacrylic resin is 1.6 or more, fluidity of the methacrylic resin is improved and the resin is easier to mold. When the dispersity (Mw/Mn) of the methacrylic resin is 2.5 or less, mechanical properties such as impact resistance, toughness, and bending resistance of the molded article obtained tend to be improved.

In the present specification, the weight average molecular weight (Mw) and the number average molecular weight (Mn) are values in terms of standard polystyrene measured by gel permeation chromatography (GPC), and are measured by the method described in Examples below.

Note that the weight average molecular weight (Mw) and the number average molecular weight (Mn) of the methacrylic resin can be controlled by adjusting the types, amounts to be used, etc. of the polymerization initiator and the chain transfer agent in synthesizing the methacrylic resin.

The methacrylic resin according to one or more embodiments is not only excellent in thermal stability, but also expected to be suitable for reuse after disposal, that is, for recycling. As a method of recycling a methacrylic resin, for example, chemical recycling (method for recovering cracked oil as a cracked product by thermal cracking and reusing it as a chemical raw material or fuel) is known. In general, in order to improve the heat resistance and thermal stability of a methacrylic resin, a cyclic structure is introduced into the molecular structure of the methacrylic resin, or a monomer having a rigid structure is copolymerized. However, these structures are unpreferable, because they are impurities in chemical recycling. In this regard, since the methacrylic resin according to one or more embodiments includes a large proportion of the structural unit derived from methyl methacrylate, and the monomer is expected to be recovered as cracked oil in a high yield, good chemical recyclability can be expected.

### <Method for Producing Methacrylic Resin>

A method for producing the methacrylic resin according to one or more embodiments includes a polymerization step of polymerizing a monomer mixture having a methyl methacrylate content of 98% by mass or more in the presence of a non-nitrile azo polymerization initiator (hereinafter, also simply referred to as “polymerization initiator”) and a chain transfer agent at 100° C. or less until the polymerization conversion ratio reaches 90% or more. As a method for producing the methacrylic resin, a conventionally known polymerization method can be employed, and for example, a radical polymerization method such as a continuous bulk polymerization method, a solution polymerization method, an emulsion polymerization method, a non-emulsifier (soap-free) emulsion polymerization method, or a suspension polymerization method can be employed. Among them, from the viewpoints of a degree of freedom in structural design of the methacrylic resin, simplicity of polymerization, productivity, etc., a production method in which aqueous polymerization is performed is preferable, a suspension polymerization method and an emulsion polymerization method are more preferable, and a suspension polymerization method is further preferable.

Note that when the methacrylic resin according to one or more embodiments is produced by the aqueous polymerization method, the method is advantageous also from the viewpoint of impurities in the resin. For example, in an anionic solution polymerization method, since an organometallic compound is used as the polymerization initiator, metal ions derived from the organometallic compound remain in the resin in an amount of several hundred ppm by mass. On the other hand, in the aqueous polymerization, since an organometallic compound is not used as the polymerization initiator, a total amount of the remaining metal ions in the resin can be 100 ppm by mass or less. When the aqueous polymerization is performed, a content of Al in the resin may be 1 ppm by mass or less, and a content of Li in the resin may be 1 ppm by mass or less. In addition, the aqueous polymerization does not require a step of removing remaining metal ions, and thus is excellent in economic efficiency. Furthermore, an organic solvent such as an aliphatic hydrocarbon or an alicyclic hydrocarbon, which is used, for example, in the anionic solution polymerization method, is not used in the aqueous polymerization, and therefore, the aqueous polymerization is also excellent in environmental aspects.

### [Suspension Polymerization Method]

In the suspension polymerization method, the methacrylic resin is synthesized in an aqueous suspension in which water, a monomer mixture, a dispersant, a polymerization initiator, a chain transfer agent, and optionally other additives are mixed. The order of mixing components is not particularly limited. For example, an aqueous suspension may be prepared by mixing the components simultaneously. Alternatively, water, a polymerization initiator, and optional other additives may be mixed to prepare an aqueous solution, followed by addition of the monomer mixture and the chain transfer agent, followed by addition of a dispersant to prepare the aqueous suspension. A mass ratio of the methacrylic resin to be obtained to water (methacrylic resin/water) may be 1.0/0.6 to 1.0/3.0.

As the monomer mixture, a monomer mixture in which the content of methyl methacrylate may be 98% by mass or more, 99% by mass or more, or 100% by mass is used.

Examples of the dispersant include sparingly water-soluble inorganic salts such as calcium triphosphate, magnesium pyrophosphate, hydroxyapatite, kaolin, etc.; water-soluble polymers such as polyvinyl alcohol, methyl cellulose, polyacrylamide and polyvinylpyrrolidone; and the like. When a sparingly water-soluble inorganic salt is used as the dispersant, it is effective to use an anionic surfactant such as sodium α-olefinsulfonate, sodium dodecylbenzenesulfonate, or the like, in combination. These dispersants may be added during the polymerization as necessary.

Examples of the non-nitrile polymerization initiator include a non-nitrile azo polymerization initiator represented by the above formula (2). Among the non-nitrile azo polymerization initiators represented by the above formula (2), at least one selected from dimethyl 2,2′-azobis(isobutyrate) or dimethyl 1,1′-azobis(1-cyclohexanecarboxylate) is preferable from the viewpoints of half-life temperature, cost, and the like.

Note that examples of the polymerization initiator generally used in the radical polymerization method include an azo polymerization initiator, a peroxide polymerization initiator, etc. It is known that free radicals generated from a polymerization initiator cause, in addition to an addition reaction to a monomer, a hydrogen abstraction reaction in the presence of a substance that easily gives hydrogen. In this regard, the azo polymerization initiator generates only alkyl radicals, and thus has lower hydrogen abstraction ability than peroxide polymerization initiators. Here, if the polymerization initiator has high hydrogen abstraction ability, for example, in a case where methyl methacrylate is used as the monomer, hydrogen is abstracted from the α-methyl group of the methyl methacrylate or the methyl group of the ester by free radicals generated from the polymerization initiator, and polymerization proceeds from radicals newly generated on the α-methyl group or methyl group of the ester. As a result, a polymer in which double bonds derived from the monomer structure remain at its terminal is easily formed. Therefore, when a polymerization initiator having a high hydrogen abstraction ability is used, the thermal stability of the methacrylic resin obtained tends to be insufficient. Thus, an azo polymerization initiator is more preferable than a peroxide polymerization initiator in order to obtain a methacrylic resin having high thermal stability.

The hydrogen abstraction ability of the polymerization initiator can be measured, for example, by a radical trapping method using an α-methylstyrene dimer (i.e., an α-methylstyrene dimer trapping method).

An amount of the polymerization initiator to be used may be 0.1 parts by mass or less, 0.05 parts by mass or less, or 0.04 parts by mass or less with respect to 100 parts by mass of a total amount of the monomer mixture. The lower limit of the amount of the polymerization initiator to be used is not particularly limited, but may be 0.001 parts by mass or more with respect to 100 parts by mass of the total amount of the monomer mixture from the viewpoint of the polymerization rate.

Examples of the chain transfer agent include primary alkyl mercaptan-based chain transfer agents such as n-butyl mercaptan, n-octyl mercaptan, n-hexadecyl mercaptan, n-dodecyl mercaptan, n-tetradecyl mercaptan, etc.; secondary alkyl mercaptan-based chain transfer agents such as s-butyl mercaptan, s-dodecyl mercaptan, etc.; tertiary alkyl mercaptan-based chain transfer agents such as t-dodecyl mercaptan, t-tetradecyl mercaptan, etc.; thioglycolic acid esters such as 2-ethylhexyl thioglycolate, ethylene glycol dithioglycolate, trimethylolpropane tris (thioglycolate), pentaerythritol tetrakis (thioglycolate), etc.; thiophenol, tetraethylthiuram disulfide, pentanephenylethane, acrolein, methacrolein, allyl alcohol, carbon tetrachloride, ethylene bromide, styrene oligomers (such as α-methylstyrene dimer, etc.), terpinolene; and the like. These chain transfer agents may be used alone or in combination of two or more types thereof.

Among these chain transfer agents, alkyl mercaptan-based chain transfer agents and thioglycolic acid esters are preferable, n-octyl mercaptan and 2-ethylhexylthioglycolate are more preferable as the alkyl mercaptan-based chain transfer agent and the thioglycolic acid ester, respectively, from the viewpoints of handling property, stability, thermal stability of the methacrylic resin to be obtained, and the like.

An amount of the chain transfer agent to be used may be 0.10 mol % or more, or 0.15 mol % or more, based on a total amount of the monomer mixture. The upper limit of the amount of the chain transfer agent to be used is not particularly limited, but may be 0.45 mol % or less with respect to the total amount of the monomer mixture.

By setting the amount of chain transfer agent to be used to the amount described above, a methacrylic resin containing a structure derived from the chain transfer agent can be obtained. In the case of using an alkyl mercaptan-based chain transfer agent or a thioglycolic acid ester, examples of the structure derived from the chain transfer agent are as follows: a structure generated by a reaction between a growing radical and hydrogen of the alkyl mercaptan-based chain transfer agent or the thioglycolic acid ester (that is, a saturated bond terminal structure); a resin structure generated by a reaction of a sulfur radical generated by abstraction of hydrogen of the alkyl mercaptan-based chain transfer agent or the thioglycolic acid ester with a monomer (that is, a resin structure containing sulfur); or the like. In the methacrylic resin according to one or more embodiments, an amount of sulfur, i.e., bonded sulfur atoms contained in the resin is 0.05 mol % or more, or 0.10 mol % or more, from the viewpoint of thermal stability of the resin. Here, an amount of bonded sulfur atoms is an amount with respect to the structural unit derived from the monomer in the methacrylic resin.

In order to reduce the proportion of terminal double bonds of the methacrylic resin to be obtained to improve thermal stability, a ratio of a total molar amount of the chain transfer agent to a total molar amount of the polymerization initiator is 2.0 or more. A ratio of a total molar amount of the chain transfer agent to the total molar amount of the polymerization initiator may be 4.0 or more, 8.0 or more, or 10 or more. The upper limit of the ratio of the total molar amount of the chain transfer agent to the total molar amount of the polymerization initiator is not particularly limited, but is preferably, for example, 50 or less.

A polymerization temperature during the synthesis of the methacrylic resin may be set to 100° C. or less, 20 to 100° C., 30 to 98° C., 50 to 96° C., or 60 to 95° C., from the viewpoints of control of syndiotacticity of the methacrylic resin to be obtained and productivity. After main reaction is completed in the polymerization in the first stage, the temperature may be raised to a higher temperature than in the first stage to perform post-polymerization in order to reduce residual monomers.

Since polymerization is started with a small amount of polymerization initiator, the polymerization reaction may be performed by lowering an amount of dissolved oxygen. An amount of dissolved oxygen in the raw material for polymerization may be 10 ppm or less, 5 ppm or less, 4 ppm or less, or 2 ppm or less. By limiting the amount of dissolved oxygen to such a range, the polymerization reaction proceeds smoothly, and coloration of the molded article of the methacrylic resin tends to be suppressed. Examples of methods for removing oxygen dissolved in the raw material for polymerization include feeding an inert gas such as a nitrogen gas continuously into the reaction vessel before, during, and after temperature rise to a predetermined polymerization temperature. In order to also remove dissolved oxygen from raw materials to be added during polymerization, it is preferable to independently supply an inert gas to the raw materials.

When a polymerization inhibitor is contained in the monomer mixture, the polymerization inhibitor may be removed by distillation or alkali extraction, or by using an adsorbent such as alumina, silica gel, molecular sieves, activated carbon, an ion exchange resin, zeolite, or acidic clay, in order to allow the polymerization reaction to proceed smoothly.

A suspension containing the methacrylic resin obtained by the suspension polymerization may be subjected to a washing operation such as acid washing, water washing, or alkali washing in order to remove the dispersant. The number of times of performing these washing operations may be selected from an optimum number of times in consideration of the working efficiency and the removal efficiency of the dispersant, and may be once or a plurality of times.

As a method of separating the methacrylic resin from the suspension containing the methacrylic resin, a conventionally known dehydration method can be employed. Examples of the dehydration method include a method using a centrifugal separator and a method of removing water by suction on a porous belt or a filtration membrane.

The methacrylic resin in a water-containing state obtained through the above dehydration can be recovered by performing a drying treatment by a conventionally known method. Examples of drying methods include: hot air drying in which drying is performed by sending hot air into a tank from a hot air blower, a blow heater, or the like; vacuum drying in which inside of a system is depressurized and heated as necessary to perform drying; barrel drying in which water is blown off by rotating the methacrylic resin obtained in a container; spin drying using centrifugal force; and the like. These drying methods may be carried out alone or in combination of two or more.

### [Emulsion Polymerization Method]

In the emulsion polymerization method, a methacrylic resin is synthesized in an emulsion in which water, a monomer mixture, an emulsifier, a polymerization initiator, a chain transfer agent, and optionally other additives are mixed.

As the monomer mixture, a monomer mixture in which a content of methyl methacrylate may be 98% by mass or more, 99% by mass or more, or 100% by mass is used.

Examples of the emulsifier include anionic surfactants such as alkylsulfonates, alkylbenzenesulfonates, dialkylsulfosuccinates, α-olefinsulfonates, naphthalenesulfonate-formaldehyde condensates, alkylnaphthalenesulfonates, N-methyl-N-acyltaurates, phosphate ester salts (polyoxyethylene alkyl ether phosphates, etc.), etc.; nonionic surfactants; and the like. Examples of salts described above include lithium salts, sodium salts, potassium salts, calcium salts, magnesium salts, etc. These emulsifiers may be used alone or in combination of two or more types thereof. The emulsifier used in the emulsion polymerization may remain in the final methacrylic resin.

When the pH of the emulsion deviates from neutral and becomes acidic or basic, an appropriate pH adjuster can be used in order to prevent hydrolysis of methyl methacrylate as a monomer or a structural unit derived from methyl methacrylate in a methacrylic resin to be obtained by polymerization. Examples of the pH adjuster to be used include boric acid-potassium chloride-potassium hydroxide, potassium dihydrogen phosphate-sodium hydrogen phosphate, boric acid-potassium chloride-potassium carbonate, citric acid-potassium hydrogen citrate, potassium dihydrogen phosphate-boric acid, sodium hydrogen phosphate-citric acid, etc.

Examples of the polymerization initiator and the chain transfer agent include the same polymerization initiators and chain transfer agents in the suspension polymerization method described above.

In order to reduce a proportion of terminal double bonds of the methacrylic resin to be obtained and improve thermal stability, a ratio of a total molar amount of the chain transfer agent to a total molar amount of the polymerization initiator is set to 2.0 or more. The ratio of the total molar amount of the chain transfer agent to the total molar amount of the polymerization initiator may be 4.0 or more, 8.0 or more, or 10 or more. The upper limit of the ratio of the total molar amount of the chain transfer agent to the total molar amount of the polymerization initiator is not particularly limited, but is preferably, for example, 50 or less.

A solid or powdery methacrylic resin can be obtained by subjecting latex of the methacrylic resin obtained by the emulsion polymerization to heat drying or spray drying, or by subjecting the latex to a known method such as adding a water-soluble electrolyte such as a salt or an acid to coagulate the latex, and further performing heat treatment, and then separating the resin component from the aqueous phase to perform drying. The salt is not particularly limited, but may be a divalent salt, and specifically, a calcium salt such as calcium chloride, calcium acetate, etc.; a magnesium salt such as magnesium chloride, magnesium sulfate, etc.; and the like.

Among these salts, magnesium salts such as magnesium chloride, magnesium sulfate, etc. are preferable. During coagulation, additives generally added, such as an anti-aging agent, an ultraviolet absorber, etc., may be added.

Before the coagulation operation described above, the latex may be filtered through a filter, a mesh, or the like to remove fine polymerization scales. This can reduce fish eyes, foreign matters, etc. caused by the fine polymerization scales, when the methacrylic resin is formed into a molded article.

In one or more embodiments, the methacrylic resin to be obtained by the aqueous polymerization may be in the form of powder, grains, or grainy powder containing both powder and grains. With regard to primary particles constituting powder, grains, and grainy powder, the suspension polymerization is suitable for preparing primary particles having an average particle diameter of about 10 to 1,000 μm, and the emulsion polymerization is suitable for preparing primary particles having an average particle diameter of about 50 to 500 nm. The powder, the grains, and the grainy powder may contain an aggregate, which is an aggregate of primary particles.

After completion of the polymerization, volatile components such as residual monomers, residual oligomers, and chain transfer agents in the methacrylic resin may be removed as necessary. The removal method is not particularly limited, but heat devolatilization is preferable. Examples of the devolatilization method include a treatment using an extruder equipped with a vent. A vent of an extruder may be a vacuum vent or an open vent, and an extruder screw may be a twin screw. The twin screw gives larger shear energy to the resin and provides a larger degree of surface renewal than a single screw and thus can efficiently perform devolatilization. A cylinder heating temperature of the extruder may be 150 to 270° C., 160 to 260° C., or 180 to 250° C. When the cylinder heating temperature is 270° C. or less, thermal decomposition of the methacrylic resin can be suppressed.

### <Resin Composition>

The resin composition according to one or more embodiments includes the methacrylic resin according to one or more embodiments described above.

The resin composition according to one or more embodiments contains an ultraviolet absorber from the viewpoint of further improving light resistance of the molded article to be obtained. The ultraviolet absorber is not particularly limited, and ultraviolet absorbers conventionally blended in various resins can be used. Examples of the ultraviolet absorber include a benzotriazole compound, a triazine compound, an oxalate anilide compound, a cyanoacrylate compound, a salicylate compound, and a benzophenone compound. Among these, a triazine compound is preferable from the viewpoint of light resistance of the resin composition.

Examples of the triazine compound include, for example, 2,4-diphenyl-6-(2-hydroxyphenyl-4-hexyloxyphenyl)-1,3,5-triazine, 2-[4,6-bis(2,4-dimethylphenyl)-1,3,5-triazin-2-yl]-5-(octyloxy)phenol, 2-(4,6-diphenyl-1,3,5-triazin-2-yl)-5-[(hexyl)oxy]phenol, 2-(4,6-diphenyl-1,3,5-triazin-2-yl)-5-[2-(2-ethylhexanoyloxy)ethoxy]phenol, 2,4,6-tris(2-hydroxy-4-alkoxy-3-methylphenyl)-1,3,5-triazine, and the like. The alkoxy group of 2,4,6-tris(2-hydroxy-4-alkoxy-3-methylphenyl)-1,3,5-triazine may be a linear or branched alkoxy group having 1 to 10 carbon atoms. Specific examples of 2,4,6-tris (2-hydroxy-4-alkoxy-3-methylphenyl)-1,3,5-triazine include 2,4,6-tris (2-hydroxy-4-hexyloxy-3-methylphenyl)-1,3,5-triazine and the like.

Among these triazine compounds, 2-(4,6-diphenyl-1,3,5-triazin-2-yl)-5-[2-(2-ethylhexanoyloxy)ethoxy]phenol and 2,4,6-tris(2-hydroxy-4-alkoxy-3-methylphenyl)-1,3,5-triazine are preferable. 2-(4,6-diphenyl-1,3,5-triazin-2-yl)-5-[2-(2-ethylhexanoyloxy)ethoxy]phenol is available as ADK Stab LA-46 (manufactured by ADEKA Corporation). 2,4,6-tris(2-hydroxy-4-hexyloxy-3-methylphenyl)-1,3,5-triazine is available as ADK Stab LA-F70 (manufactured by ADEKA Corporation). These ultraviolet absorbers may be used alone or as a mixture of two or more thereof.

When the resin composition according to one or more embodiments includes an ultraviolet absorber, an amount of the ultraviolet absorber to be used is not uniform, depending on the type of the ultraviolet absorber and the use conditions, but may be 0.1 to 5 parts by mass, or 0.2 to 3 parts by mass, with respect to 100 parts by mass of the methacrylic resin. When the amount of the ultraviolet absorbent to be used is 0.1 parts by mass or more, an ultraviolet absorbing effect can be improved. Further, when the amount of the ultraviolet absorber to be used is 5 parts by mass or less, coloring of the molded article obtained can be suppressed, and deterioration of transparency due to an increase in haze of the molded article can be suppressed.

In addition, the resin composition according to one or more embodiments includes multilayer structure polymer particles from the viewpoint of further improving the thermal stability and mechanical properties of the molded article to be obtained. The multilayer structure polymer particles are not particularly limited, and known multilayer structure polymer particles can be appropriately used.

In a case where the resin composition according to one or more embodiments includes the multilayer structure polymer particles, blending proportions of the methacrylic resin and the multilayer structure polymer particles vary depending on the use or the like of the molded article, but a blending amount of the methacrylic resin is 30 to 98 parts by mass and a blending amount of the multilayer structure polymer particles is 2 to 70 parts by mass with respect to 100 parts by mass of a total blending amount of both components.

The resin composition according to one or more embodiments may further contain known additives such as a light stabilizer, a heat stabilizer, a matting agent, a light diffusing agent, a coloring agent, a dye, a pigment, an antistatic agent, a thermal radiation reflecting material, a lubricant, a plasticizer, a stabilizer, a flame retardant, a mold release agent, a polymer processing aid, a filler, etc. and a resin other than the methacrylic resin. Examples of the resin other than the methacrylic resin include styrene-based resins such as an acrylonitrile styrene resin, a styrene maleic anhydride resin, etc.; a polycarbonate resin; a polyvinyl acetal resin; a cellulose acylate resin; fluororesins such as polyvinylidene fluoride, a polyfluoroalkyl (meth)acrylate resin, etc.; silicone-based resins; polyolefin-based resins; a polyethylene terephthalate resin; a polybutylene terephthalate resin; and the like.

In addition, in order to adjust orientation birefringence of the molded article, the resin composition according to one or more embodiments may include inorganic fine particles having birefringence described in Japanese Patent No. 3648201, Japanese Patent No. 4336586, or the like, and/or a low molecular weight compound having a molecular weight of 5,000 or less (or 1,000 or less) having birefringence described in Japanese Patent No. 3696649.

A form of the resin composition according to one or more embodiments is not particularly limited, and the resin composition may be in the form of powder, may be in the form of grains, may be in the form of grainy powder containing both powder and grains, or may be in the form of pellets.

### <Molded Article>

The methacrylic resin according to one or more embodiments or the resin composition according to one or more embodiments can be formed into a molded article by a known molding method. Examples of the molding method include melt molding methods such as a T-die method (lamination method, coextrusion method, etc.), an inflation method (coextrusion method, etc.), a compression molding method, a blow molding method, a calender molding method, a vacuum molding method, and an injection molding method (an insert method, a two-color method, a press method, a core back method, a sandwich method and the like); a solution casting method; and the like.

### <Resin Film>

The resin film according to one or more embodiments includes the methacrylic resin according to one or more embodiments described above. The resin film according to one or more embodiments is produced, for example, by a melt extrusion method using the resin composition according to one or more embodiments described above. When a resin film is produced by the melt extrusion method, first, the resin composition according to one or more embodiments is pre-dried, then fed to an extruder, heated and melted, and fed to a T-die. Next, the resin composition fed to the T-die is extruded as a sheet-shaped molten resin and cooled and solidified using a cooling roll or the like to obtain a resin film.

The thickness of the resin film according to one or more embodiments is, for example, 500 μm or less, 300 μm or less, or 200 μm or less. The thickness of the resin film according to one or more embodiments is, for example, 10 μm or more, 30 μm or more, 50 μm or more, or 60 μm or more. The resin film having a thickness within the above range is advantageous in that the resin film is less likely to deform when vacuum molding is performed using the resin film, and breakage is less likely to occur in a deep drawn portion. Further, the resin film is also advantageous in that a resin film having uniform optical properties and excellent transparency can be manufactured.

A total light transmittance of the resin film according to one or more embodiments is 85% or more, 88% or more, or 90% or more. When the total light transmittance is in the above range, transparency is high, and thus the film can be suitably used for optical applications requiring light transmittability.

A glass transition temperature of the resin film according to one or more embodiments is 110° C. or higher, 115° C. or higher, or 120° C. or higher. When the glass transition temperature is within the above range, heat resistance of the resin film becomes sufficient.

Haze of the resin film according to one or more embodiments is 2.0% or less, 1.5% or less, 1.3% or less, or 1.0% or less. Internal haze of the resin film may be 1.5% or less, 1.0% or less, 0.5% or less, or 0.4% or less. When the haze and the internal haze are within the above ranges, transparency is high, and thus the film can be suitably used for optical applications requiring light transmittability. Note that the haze is composed of haze inside a film and haze on a film surface (external), each haze being denoted as internal haze and external haze, respectively.

YI (Yellow Index) of the resin film according to one or more embodiments is 1.2 or less, or 1.0 or less. When YI is in the above range, transparency is high, and therefore, the composition can be suitably used for optical applications requiring light transmittability.

The resin film according to one or more embodiments includes an ultraviolet absorber from the viewpoint of further improving light resistance. The ultraviolet absorber aims at improving light resistance by absorbing ultraviolet rays having a wavelength of 400 nm or less. In the resin film according to one or more embodiments, a transmittance at a wavelength of 380 nm is in the range of 2% to 30%, in the range of 4% to 20%, or in the range of 5% to 10%.

The resin film according to one or more embodiments can be suitably used as an optical film such as a polarizer protective film, etc. When the resin film according to one or more embodiments is used as the polarizer protective film, it is preferable that optical anisotropy is small. In particular, not only the optical anisotropy in the in-plane direction (length direction or width direction) of the resin film but also optical anisotropy in the thickness direction may be small. That is, it is preferable that absolute values of in-plane retardation and thickness direction retardation are both small. For example, when a measurement wavelength is 590 nm, an absolute value of the in-plane retardation may be 20 nm or less, or 15 nm or less. An absolute value of the thickness direction retardation may be 50 nm or less, 20 nm or less, or 15 nm or less.

The retardation is an index value calculated based on birefringence. The in-plane retardation (Re) and the thickness direction retardation (Rth) can be calculated by the respective equations below. In an ideal resin film that is perfectly optically isotropic in the three-dimensional direction, both the in-plane retardation Re and the thickness direction retardation Rth are 0.

$$Re = ( nx - ny ) \times d \\ Rth = [ ( nx + ny ) / 2 - nz ] \times d$$

In the above formula, nx, ny, and nz represent refractive indexes in respective axial directions, provided that an in-plane stretching direction (orientation direction of the polymer chain) is defined as X axis, a direction perpendicular to the X axis is defined as Y axis, and a thickness direction of the resin film is defined as Z axis. In addition, d represents the thickness of the resin film, and nx-ny represents orientation birefringence. A MD direction of the film is defined as the X-axis, but in the case of a stretched film, the stretching direction is defined as the X-axis.

In the resin film according to one or more embodiments, the value of orientation birefringence is −5.0×10⁻⁴ to 5.0×10⁻⁴, −4.0×10⁻⁴ to 4.0×10⁻⁴, or −3.8×10⁻⁴ to 3.8×10⁻⁴. When the orientation birefringence is in the above range, there is a tendency that stable optical characteristics can be obtained without causing birefringence during molding.

### (Stretching)

The resin film according to one or more embodiments may be further stretched. By stretching the resin film, it is possible to improve mechanical strength and film thickness accuracy of the resin film.

When the resin film according to one or more embodiments is stretched, a resin film in an unstretched state is once molded from the resin composition according to one or more embodiments, and then uniaxial stretching or biaxial stretching is performed. Thereby, a stretched film (uniaxially stretched film or biaxially stretched film) can be produced.

A stretching ratio of the stretched film is not particularly limited, and is appropriately determined according to the mechanical strength, surface properties, thickness accuracy, and the like of the stretched film to be produced. Although it also depends on the stretching temperature, the stretching ratio may be generally selected in the range of 1.1 to 5 times, in the range of 1.3 to 4 times, or in the range of 1.5 to 3 times. Within the stretching ratio in the range described above, mechanical properties of the film such as elongation, tear propagation strength, and kneading resistance of the film tend to be significantly improved.

### (Applications)

The resin film according to one or more embodiments can be used for various applications such as transportation equipment, solar cell members, civil engineering building members, daily goods, electric and electronic devices, optical members, and medical products. In particular, since the resin film according to one or more embodiments has excellent heat resistance and optical properties, it can be suitably used for optical applications. Examples of optical applications include a front plate (cover window) of various display devices, a diffusion plate, a polarizer protective film, a polarizing plate protective film, a retardation film, a light diffusion film, and an optical isotropic film.

Among these, the resin film according to one or more embodiments can be suitably used as a polarizer protective film or a front plate (cover window) of a display device. When the resin film according to one or more embodiments is used as a front plate (cover window) of various display devices, a functional coating layer such as a primer layer or a hard coat layer may be formed on at least one main surface of the resin film as necessary. When the resin film according to one or more embodiments is used as a polarizer protective film, the resin film according to one or more embodiments is bonded to a polarizer to form a polarizing plate. The polarizer is not particularly limited, and any conventionally known polarizer can be used. The polarizing plate is used, for example, in a display device such as a liquid crystal display device, an organic EL display device, etc.

### EXAMPLES

Hereinafter, the one or more embodiments of the present invention will be described more specifically based on Examples and Comparative Examples, but one or more embodiments of the present invention are not limited to the following Examples. The measurement methods of various physical properties described in Examples and Comparative Examples are as follows.

### (1) Polymerization Conversion Ratio

The polymerization conversion ratio of the methacrylic resin was determined from a ratio of a weight of a methacrylic resin obtained by washing with water, followed by drying, with respect to a weight of monomers used. As for a weight of the methacrylic resin obtained by washing with water, followed by drying, a value obtained by subtracting a weight of remaining monomers in the methacrylic resin obtained by the following analysis was used. As for weights of methacrylic resins of Comparative Examples 2 and 3, weights of the methacrylic resins obtained by precipitation purification after polymerization were used as they were.

### (Analysis Conditions)

Using a gas chromatograph (7890B manufactured by Agilent Technologies) and DB-1 (film thickness 0.8 μm×inner diameter 0.20 mm×length 30 m manufactured by Agilent Technologies) as an analytical column, analysis was carried out at an inlet temperature of 150° C. and a detector temperature of 320° C. The column temperature was set to the following conditions: the column temperature was raised from 35° C. to 210° C. at a temperature rising rate of 30° C./min, then raised from 210° C. to 260° C. at a temperature rising rate of 10° C./min, further raised from 260° C. to 320° C. at a temperature rising rate of 20° C./min, and held for 3 minutes. A calibration curve was prepared according to an internal reference method using chlorobenzene as an internal reference substance. Remaining amount of monomers in the methacrylic resin was calculated, and then the polymerization conversion ratio was calculated.

### (2) Triad Syndiotacticity (Rr)

A ¹H-NMR spectrum of a methacrylic resin was measured in a deuterated chloroform solution at 22° C. for 16 integrations using a nuclear magnetic resonance apparatus (AVANCE III 400 MHz manufactured by Bruker). From the spectrum, an area (X) of a region of 0.60 to 0.95 ppm and an area (Y) of a region of 0.60 to 1.25 ppm were measured, provided that tetramethylsilane (TMS) is assigned as 0 ppm, and then triad syndiotacticity (rr) was calculated, using the formula: (X/Y)×100.

### (3) Weight Average Molecular Weight (Mw), and Ratio of Weight Average Molecular Weight (Mw) and Number Average Molecular Weight (Mn)

A weight average molecular weight (Mw), a number average molecular weight (Mn), and a ratio of the weight average molecular weight (Mw) and the number average molecular weight (Mn) of the methacrylic resin were calculated by a standard polystyrene conversion method using gel permeation chromatography (GPC). Specifically, analysis was carried out on the following apparatus under the following conditions, using a sample solution prepared by dissolving 20 mg of a methacrylic resin in 10 mL of tetrahydrofuran.
Measuring instrument: HLC-8220 GPC(Tosoh)
Detector: RI detector
Solvent: tetrahydrofuran
Guard column: TSKgel guard column SuperHZ-H(Tosoh)
Analytical column: TSKgel SuperHZM-H×2 (Tosoh)
Measurement temperature: 40° C.
Standard material: standard polystyrene (Tosoh)

### (4) Percentage of Terminal Double Bonds

As for Examples 1 to 5 and Comparative Example 1, a methacrylic resin was dissolved in methylene chloride and the solution was added dropwise to methanol to precipitate and purify the resin, as a pretreatment. The precipitated resin was collected by suction filtration and dried, and the resin obtained was subjected to analysis. As for Comparative Examples 2 and 3, a reaction solution after polymerization was added dropwise to methanol for precipitation purification, and the resin obtained after drying was subjected to analysis as it was. A solution was prepared by dissolving 20 mg of the dried methacrylic resin in 0.6 to 0.7 mL of deuterated chloroform, and ¹H-NMR measurement was performed using a nuclear magnetic resonance apparatus (AVANCE NEO 700 MHz manufactured by Bruker). The measurement temperature and the number of times of integration were set to 20° C. and 8,192 times, respectively, and the measurement was performed while erasing a methoxy group-derived peak (3.60 ppm, which is a value when the chemical shift of the solvent was assumed to be 7.26 ppm) of the methacrylic resin by using Excitation Sculpting (ES) method, which is a type of solvent erasing methods. From the obtained ¹H-NMR spectrum, a total area (X) of peaks (5.47 to 5.53 ppm and 6.21 ppm) derived from the terminal double bond portion of the methacrylic resin and an area (Y) of peaks (0.5 to 1.25 ppm) derived from the α-methyl group of the methacrylic resin were determined, and then a proportion of terminal double bonds of the methacrylic resin was calculated by the formula: [(3×X)/(2×Y)×100.

### (5) Glass Transition Temperature (Tg)

A glass transition temperature of the methacrylic resin was measured by the following method. As the pretreatment, heat treatment was performed using a thermogravimetric analyzer (STA7200 manufactured by Hitachi High-Tech Science) for the purpose of removing residual monomers and decomposition products of the polymerization initiator in the methacrylic resin. Specifically, the temperature was raised from 40° C. to 270° C. at a temperature rising rate of 10° C./min under a nitrogen gas flow of 200 mL/min, and heat treatment was performed under the condition of holding the temperature at 270° C. for 2.0 to 2.5 minutes. The glass transition temperature (Tg) of the methacrylic resin after the heat treatment was measured using a differential scanning calorimeter (DSC; DSC7000X manufactured by Hitachi High-Tech Science). First, DSC measurement was carried out under the conditions that a first temperature rise was carried out from 40° C. to 160° C. at a temperature rising rate of 10° C./min under a nitrogen flow rate of 40 mL/min, and after cooling to 40° C., a second temperature rise was carried out from 40° C. to 160° C. at a temperature rising rate of 10° C./min. Then, midpoint glass transition temperature was read from the DSC curve measured during the second temperature rise (the midpoint glass transition temperature is a temperature of a point at which a straight line equidistant in the vertical axis direction from both a straight line obtained by extrapolating the baseline before the inflection point to the high temperature side and a straight line obtained by extrapolating the baseline after the inflection point to the low temperature side intersects the curve of the stepwise change portion of the glass transition).

### (6) Residence Heat Stability

Residence heat stability of the methacrylic resin was evaluated using a thermogravimetric analyzer (STA7200 manufactured by Hitachi High-Tech Science). First, in order to remove residual monomers and decomposition products of the polymerization initiator in the methacrylic resin, the sample was heat-treated under the condition that the temperature was raised from 40° C. to 270° C. at a temperature rising rate of 10° C./min under a nitrogen gas flow of 200 mL/min, and was held at 270° C. for 2.0 to 2.5 minutes. Then, a mass change was recorded under the condition that after cooling to 40° C., the temperature was raised from 40° C. to 280° C. at a temperature rising rate of 10° C./min, and was held at 280° C. for 30 minutes.

Residence heat stability was evaluated from a mass reduction rate calculated by [(X₀-X₁₅)/X₀]×100, where the mass when the sample temperature reached 280° C. was determined as X₀, and the mass when the sample was held at 280° C. for 15 minutes was determined as X₁₅.

### (7) Atomic Amount of Bonded Sulfur

An amount of bonded sulfur atoms in the methacrylic resin was determined as follows. As a pretreatment, a methacrylic resin was dissolved in methylene chloride, and the solution was added dropwise to methanol to precipitate and purify the resin. The precipitated resin was collected by suction filtration and dried and the resin obtained was subjected to analysis. An appropriate amount of the dried methacrylic resin was accurately weighed and diluted to a specific volume, the diluted methacrylic resin was set in an automatic sample burner (AQF-2100 manufactured by Nittoseiko Analytech) and decomposed at a high temperature. The generated gas was absorbed by ultrapure water containing an aqueous hydrogen peroxide solution and hydrazine hydrate. Sulfate ions were quantified on an ion chromatograph (Thermo Fisher Scientific, Integrion RFIC, Column: AG18-4 μm, AS18-4 μm), using the liquid obtained (decomposed gas aqueous solution). Next, mass Wp (mass %) of sulfur atoms per mass of the dried methacrylic resin was calculated. Further, an amount Sp (mol %) of bound sulfur atoms was calculated by the following formula.

$$Sp = Wp \times ( 100 / 32 )$$

### (8) Haze Measurement

Haze of the stretched resin film was measured using a haze meter (HZ-V3 manufactured by Suga Test Instruments) in accordance with JIS K7136. Further, both surfaces of the resin film were sandwiched by glycerin and then glass in this order, and a value obtained by performing the same measurement was defined as an internal haze. The result obtained was converted to a film thickness equivalent to 40 μm.

### (9) Total Light Transmission

A total light transmittance of the stretched resin film was measured using a haze meter (HZ-V3 manufactured by Suga Test Instruments) in accordance with JIS K7361-1.

### (10) Light Transmittance at a Wavelength of 380 nm

A light transmittance of the stretched resin film at a wavelength of 380 nm was measured using an ultraviolet-visible spectrophotometer (V-560 manufactured by JASCO Corporation).

### (11) YI

YI of the stretched resin film was measured using a spectrophotometer (SC-P manufactured by Suga Test Instruments) in accordance with JIS K7373. The result obtained was converted to a film thickness equivalent to 40 μm.

### Example 1

170 parts by mass of deionized water, 0.10 parts by mass of disodium hydrogen phosphate as the suspension aid, and 0.037 parts by mass of dimethyl 2,2′-azobis(isobutyrate) (V-601 manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a monomer solution containing 100 parts by mass of methyl methacrylate (MMA) and 0.322 parts by mass of n-octylmercaptan (n-OM) as the chain transfer agent was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 81° C. to start polymerization. The monomer was allowed to react at 81° C. for 4.5 hours, and then the temperature of the liquid in the reactor was raised to 95° C. The reaction mixture was stirred at the same temperature for 1 hour to terminate the polymerization. The average temperature throughout the entire polymerization, from heating to 81° C. until polymerization completion, was 84° C. The resin obtained was washed with deionized water in an amount of 3.9 times the amount of the resin obtained, followed by drying to obtain a methacrylic resin in the form of beads. The physical properties of the methacrylic resin obtained are shown in Table 1.

### Example 2

170 parts by mass of deionized water, 0.10 parts by mass of disodium hydrogen phosphate as the suspension aid, and 0.037 parts by mass of dimethyl 2,2′-azobis(isobutyrate) (V-601 manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a monomer solution containing 100 parts by mass of methyl methacrylate (MMA) and 0.220 parts by mass of n-octylmercaptan (n-OM) as the chain transfer agent was added to the reactor.

Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 78° C. to start polymerization. The monomer was allowed to react at 78° C. for 6.5 hours, and then the temperature of the liquid in the reactor was raised to 93° C. The reaction mixture was stirred at the same temperature for 1 hour to terminate the polymerization. The average temperature throughout the entire polymerization, from heating to 78° C. until polymerization completion, was 80° C. The resin obtained was washed with deionized water in an amount of 2.9 times the amount of the resin obtained, followed by drying to obtain a methacrylic resin in the form of beads. The physical properties of the methacrylic resin obtained are shown in Table 1.

### Example 3

150 parts by mass of deionized water, 0.140 parts by mass of calcium triphosphate as the dispersant, 0.0075 parts by mass of sodium α-olefinsulfonate, and 0.30 parts by mass of sodium chloride were charged into a 4-liter glass reactor equipped with an H-type stirring blade type stirrer. While stirring the aqueous solution in the reactor at 250 rpm, a nitrogen gas (oxygen concentration: 0.2 ppm) was bubbled to replace the air in the reactor, and then a monomer solution containing 100 parts by mass of methyl methacrylate (MMA), 0.289 parts by mass of n-octylmercaptan (n-OM) as the chain transfer agent, and 0.037 parts by mass of dimethyl 2,2′-azobis(isobutyrate) (V-601 manufactured by Fujifilm Wako Pure Chemical) as the polymerization initiator was added to the reactor. Thereafter, the temperature of the liquid in the reactor was raised to 80° C. to start polymerization. At 1 hour and 40 minutes from the start of polymerization, 0.10 parts by mass of additional calcium triphosphate was added to the reaction solution. Thereafter, the temperature of the liquid in the reactor was increased stepwise so that the temperature reached 87° C. at 4 hours from the start of polymerization. At that point in time, 0.22 parts by mass of calcium triphosphate was added to the reaction solution. After another 10 minutes, 0.037 parts by mass of dimethyl 2,2′-azobis(isobutyrate) was added to the reaction solution. Subsequently, the temperature of the liquid in the reactor was raised to 95° C., and stirring was continued at 95° C. for 1 hour and 30 minutes, at which point the polymerization was terminated. The average temperature throughout the entire polymerization, from heating to 80° C. until polymerization completion, was 87° C. Acid washing was performed using a 1 N hydrochloric acid solution in an amount of 0.1 times in terms of weight ratio, with respect to the amount of the monomer charged, followed by washing with water and drying to obtain a methacrylic resin in the form of beads. The physical properties of the methacrylic resin obtained are shown in Table 1.

The methacrylic resin obtained was extruded at a resin temperature of 255° C. using an intermeshed co-rotation twin screw extruder (KZW15TWIN-45MG with L/D=45 manufactured by Technobel) having a diameter of 15 mm. The resin discharged as a strand from a die provided at the outlet of the extruder was cooled in a water bath, and then pelletized in a pelletizer to obtain a resin composition.

The resin composition obtained was dried at 90° C. for 4 hours, and then extruded at a resin temperature of 240° C. using an intermeshed co-rotation twin screw extruder (KZW15TWIN-45MG with L/D=45 manufactured by Technobel) having a T-die at an outlet of the extruder and having a diameter of 15 mm. The molten resin in the form of sheet extruded from the T die was cooled by a cooling roll to obtain a resin film having a width of 130 mm and a thickness of 160 μm.

A small piece of 100 mm×100 mm was cut out from the resin film obtained so that the two sides were parallel to the extrusion direction. The small piece was set in a pantograph biaxial stretching apparatus and simultaneously biaxially stretched at 137° C. by two times in a direction parallel to the extrusion direction and by two times in a direction perpendicular to the extrusion direction. The stretching speed in each direction was 100 mm/min. Thereafter, the resultant was taken out at room temperature and rapidly cooled to obtain a resin film having a thickness of 39 μm. The physical properties of the resin film are shown in Table 1.

### Example 4

To 100 parts by mass of the methacrylic resin obtained in Example 3, 0.7 parts by mass of an ultraviolet absorber (ADK Stab LA-F70 manufactured by ADEKA Corporation) was mixed, and the mixture was kneaded and extruded at 255° C. in an intermeshed co-rotation twin screw extruder (KZW15TWIN-45MG with L/D=45 manufactured by Technobel) having a diameter of 15 mm. The resin discharged as a strand from a die provided at the outlet of the extruder was cooled in a water bath, and then pelletized in a pelletizer to obtain a resin composition.

Using the resin composition obtained, a resin film having a width of 130 mm and a thickness of 160 μm was obtained in the same manner as in Example 3. Then, the resin film was subjected to simultaneous biaxial stretching in the same manner as in Example 3 to obtain a resin film having a thickness of 39 μm. The physical properties of the resin film are shown in Table 1.

### Example 5

150 parts by mass of deionized water, 0.400 parts by mass of calcium triphosphate as the dispersant, 0.0075 parts by mass of sodium α-olefinsulfonate, and 0.30 parts by mass of sodium chloride were charged into a glass sample bottle. A monomer solution containing 100 parts by mass of methyl methacrylate (MMA), 0.093 parts by mass of dimethyl 2,2′-azobis(isobutyrate) (V-601 manufactured by Fujifilm Wako Pure Chemical) as the polymerization initiator, and 0.289 parts by mass of n-octylmercaptan (n-OM) as the chain transfer agent was added to the aqueous solution in the sample bottle while being stirred with a stirrer. The suspension in the sample bottle was transferred to a 120 mL metal pressure-resistant vessel equipped with a semicircular stirrer, and then a nitrogen gas (oxygen concentration: 0.2 ppm) was bubbled to replace the air in the reaction vessel while stirring at 150 rpm. Thereafter, the temperature of the liquid in the reaction vessel was raised to 97° C. to start the polymerization, and the reaction was carried out for 5 hours and 20 minutes, at which point the polymerization was terminated. The average temperature throughout the entire polymerization, from heating to 97° C. until polymerization completion, was 97° C. The liquid in the reaction vessel was discharged after cooling, and acid washing was performed using 1 N hydrochloric acid in an amount of 0.5 times in a weight ratio, with respect to the amount of the monomer charged, followed by washing with water and drying to obtain a methacrylic resin in the form of beads. The physical properties of the methacrylic resin obtained are shown in Table 1.

### Comparative Example 1

170 parts by mass of deionized water, 0.10 parts by mass of disodium hydrogen phosphate as the suspension aid, and 0.040 parts by mass of 2,2′-azobis(2,4-dimethylvaleronitrile) (V-65 manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a monomer solution containing 100 parts by mass of methyl methacrylate (MMA) and 0.322 parts by mass of n-octylmercaptan (n-OM) as the chain transfer agent was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 70° C. to start polymerization. The monomer was allowed to react at 70° C. for 6 hours, and then the temperature of the liquid in the reactor was raised to 95° C. The reaction mixture was stirred at the same temperature for 1 hour to terminate the polymerization. The average temperature throughout the entire polymerization, from heating to 70° C. until polymerization completion, was 74° C. The resin obtained was washed with deionized water in an amount of 7.0 times the amount of the resin obtained, followed by drying to obtain a methacrylic resin in the form of beads. The physical properties of the methacrylic resin obtained are shown in Table 1.

### Comparative Example 2

1800 parts by mass of o-dichlorobenzene as the polymerization solvent were added to a 120 mL metal pressure vessel equipped with a U-shaped stirrer, and a monomer solution containing 100 parts by mass of methyl methacrylate (MMA), 0.037 parts by mass of dimethyl 2,2′-azobis(isobutyrate) (V-601 manufactured by Fujifilm Wako Pure Chemical Corporation) as the polymerization initiator, and 0.289 parts by mass of n-octylmercaptan (n-OM) as the chain transfer agent was further added. After a nitrogen gas (oxygen concentration: 50 ppm) was bubbled into the reaction vessel to replace the air in the reaction vessel, the temperature of the liquid in the reaction vessel was raised to about 140° C. while stirring, to start polymerization. The monomer was further reacted at about 140° C. for 6 hours, at which point the polymerization was terminated. The average temperature throughout the entire polymerization, from heating to about 140° C. until polymerization completion, was 142° C. The solution in the reaction vessel was discharged after cooling, and the reaction solution was dropped into methanol to precipitate a resin. The precipitated resin was collected by filtration and dried to obtain a methacrylic resin. The physical properties of the methacrylic resin obtained are shown in Table 1.

### Comparative Example 3

339 parts by mass of methanol as the polymerization solvent were added to a 2-liter glass reactor equipped with a three-way sweptback blade type stirrer, and a monomer solution containing 100 parts by mass of methyl methacrylate (MMA), 2.46 parts by mass of dimethyl 2,2′-azobis(isobutyrate) (V-601 manufactured by Fujifilm Wako Pure Chemical Corporation) as the polymerization initiator was further added. While stirring the aqueous solution in the reactor at 220 rpm, a nitrogen gas (oxygen concentration: 0.2 ppm) was bubbled into the reactor to replace the air in the reactor, and then the temperature of the liquid in the reactor was raised to 60° C. while stirring to start polymerization. The monomer was reacted at 60° C. for another 3 hours, at which point the polymerization was terminated. At that point in time, the resulting resin precipitated out at the bottom of the reaction vessel. The average temperature throughout the entire polymerization, from heating to 60° C. until polymerization completion, was 60° C. After cooling the liquid in the reaction vessel, the resin precipitated at the bottom of the reaction vessel was dissolved in 400 parts by mass of chloroform, and the chloroform solution was added dropwise to 2,500 parts by mass of methanol to reprecipitate the resin. The reprecipitated resin was collected by filtration and dried to obtain a methacrylic resin. The physical properties of the methacrylic resin obtained are shown in Table 1.

TABLE 1

| Raw | | | | | | | |
|---|---|---|---|---|---|---|---|
| material | | | | Example | Example | Example | Example |
| for resin | Name | | Unit | 1 | 2 | 3 | 4 |
| | Monomer | Methyl | % by | 100 | 100 | 100 | 100 |
| | | methacrylate | mass | | | | |
| | | | mol % | 100 | 100 | 100 | 100 |
| | Polymeri- | Dimethyl | % by | 0.037 | 0.037 | 0.074 | 0.074 |
| | zation | 2,2′-azobis | mass | | | | |
| | initiator | (isobutyrate) | mol % | 0.016 | 0.016 | 0.032 | 0.032 |
| | | 2, 2′-azobis (2, 4- | % by | — | — | — | — |
| | | dimethyl- | mass | | | | |
| | | valeronitrile) | mol % | — | — | — | — |
| | Chain | n-octyl | % by | 0.322 | 0.220 | 0.289 | 0.289 |
| | transfer | mercaptan | mass | | | | |
| | agent | | mol % | 0.220 | 0.151 | 0.198 | 0.198 |
| Production | Average polymerization | | ° C. | 84 | 80 | 87 | 87 |
| conditions | temperature | | | | | | |
| for resin | | | | | | | |
| Ratio of | Chain transfer agent/ | | Molar | 14/1 | 9.3/1 | 6.1/1 | 6.1/1 |
| amounts | polymerization initiator | | ratio | | | | |
| of raw | | | | | | | |
| materials | | | | | | | |
| used | | | | | | | |
| Polymerization conversion ratio | | | % | 95 | 96 | 91 | 91 |
| Methacrylic resin/ultraviolet absorber | | | Mass | — | — | 100/0 | 100/0.7 |
| ratio in the resin composition | | | ratio | | | | |
| | | | | | Compar- | Compar- | Compar- |
| Raw | | | | | ative | ative | ative |
| material | | | | Example | Example | Example | Example |
| for resin | Name | | Unit | 5 | 1 | 2 | 3 |
| | Monomer | Methyl | % by | 100 | 100 | 100 | 100 |
| | | methacrylate | mass | | | | |
| | | | mol % | 100 | 100 | 100 | 100 |
| | Polymeri- | Dimethyl | % by | 0.093 | — | 0.037 | 2.46 |
| | zation | 2,2′-azobis | mass | | | | |
| | initiator | (isobutyrate) | mol % | 0.040 | — | 0.016 | 1.07 |
| | | 2, 2′-azobis (2, 4- | % by | — | 0.040 | — | — |
| | | dimethyl- | mass | | | | |
| | | valeronitrile) | mol % | — | 0.016 | — | — |
| | Chain | n-octyl | % by | 0.289 | 0.322 | 0.289 | — |
| | transfer | mercaptan | mass | | | | |
| | agent | | mol % | 0.198 | 0.220 | 0.198 | — |
| Production | Average polymerization | | ° C. | 97 | 74 | 142 | 60 |
| conditions | temperature | | | | | | |
| for resin | | | | | | | |
| Ratio of | Chain transfer agent/ | | Molar | 4.9/1 | 14/1 | 12/1 | — |
| amounts | polymerization initiator | | ratio | | | | |
| of raw | | | | | | | |
| materials | | | | | | | |
| used | | | | | | | |
| Polymerization conversion ratio | | | % | 90 | 90 | 4 | 50 |
| Methacrylic resin/ultraviolet absorber | | | Mass | — | — | — | — |
| ratio in the resin composition | | | ratio | | | | |
| (continued) | | | | | | | |
| Physical | | | | Example | Example | Example | Example |
| properties | Item | | Unit | 1 | 2 | 3 | 4 |
| | Resin | Syndiotacticity | % | 59 | 58 | 57 | 57 |
| | | Weight average | — | 80,000 | 108,000 | 80,000 | 80,000 |
| | | molecular weight | | | | | |
| | | (Mw) | | | | | |
| | | Weight average | — | 1.79 | 1.77 | 1.75 | 1.75 |
| | | molecular weight | | | | | |
| | | (Mw) /number | | | | | |
| | | average molecular | | | | | |
| | | weight (Mn) | | | | | |
| | | Amount of terminal | mol % | 0.005 | 0.004 | 0.005 | 0.005 |
| | | double bond | | | | | |
| | | Glass transition | ° C. | 124 | 123 | 123 | 123 |
| | | temperature (Tg) | | | | | |
| | | Residence heat | % | 1.7 | 2.2 | 1.6 | 1.6 |
| | | stability | | | | | |
| | | (Weight reduction | | | — | | |
| | | rate at 280° C. for | | | | | |
| | | 15 min) | | | | | |
| | | Atomic amount of | mol % | 0.159 | — | — | — |
| | | bound sulfur | | | | | |
| | Resin | Haze | % | — | — | 0.26 | 0.17 |
| | film | Internal haze | % | — | — | 0.08 | 0.09 |
| | (After | Total light | % | — | — | 92.5 | 92.5 |
| | stretching) | transmittance | | | | | |
| | | Light transmittance | % | — | — | 91.5 | 10.3 |
| | | at wavelength | | | | | |
| | | of 380 nm | | | | | |
| | | YI | — | — | — | 0.16 | 0.69 |
| (continued) | | | | | | | |
| | | | | | Compar- | Compar- | Compar- |
| | | | | | ative | ative | ative |
| Physical | | | | Example | Example | Example | Example |
| properties | Item | | Unit | 5 | 1 | 2 | 3 |
| | Resin | Syndiotacticity | % | 55 | 60 | 54 | 60 |
| | | Weight average | — | 76,000 | 74,000 | 40,000 | 82,000 |
| | | molecular weight | | | | | |
| | | (Mw) | | | | | |
| | | Weight average | — | 1.73 | 1.75 | 1.34 | 1.80 |
| | | molecular weight | | | | | |
| | | (Mw) /number | | | | | |
| | | average molecular | | | | | |
| | | weight (Mn) | | | | | |
| | | Amount of terminal | mol % | 0.011 | 0.007 | 0.045 | 0.062 |
| | | double bond | | | | | |
| | | Glass transition | ° C. | 121 | 124 | 114 | 123 |
| | | temperature (Tg) | | | | | |
| | | Residence heat | % | 2.0 | 2.7 | 3.7 | 5.3 |
| | | stability | | | | | |
| | | (Weight reduction | | | | | |
| | | rate at 280° C. for | | | | | |
| | | 15 min) | | | | | |
| | | Atomic amount of | mol % | — | — | — | — |
| | | bound sulfur | | | | | |
| | | Haze | % | — | — | — | — |
| | Resin | Internal haze | % | — | — | — | |
| | film | Total light | % | — | — | — | — |
| | (After | transmittance | | | | | |
| | stretching) | Light transmittance | % | — | — | — | — |
| | | at wavelength | | | | | |
| | | of 380 nm | | | | | |
| | | YI | — | — | — | — | — |

As shown in Table 1, in Example 1 in which dimethyl 2,2′-azobis(isobutyrate) as the non-nitrile azo polymerization initiator was used, the weight reduction rate when held at 280° C. for 15 minutes was smaller, and the residence heat stability was higher as compared with Comparative Example 1 in which 2,2′-azobis(2,4-dimethylvaleronitrile) as the nitrile azo polymerization initiator was used at the same use ratio (mol %). Further, also in Example 2 in which the use ratio (mol %) of dimethyl 2,2′-azobis(isobutyrate) as the non-nitrile azo polymerization initiator was the same as that of Example 1 and the use ratio (mol %) of n-octylmercaptan (n-OM) as the chain transfer agent was smaller than that of Example 1, the weight reduction rate when held at 280° C. for 15 minutes was smaller and the residence heat stability was higher as compared with Comparative Example 1 in which 2,2′-azobis(2,4-dimethylvaleronitrile) as the nitrile azo polymerization initiator was used. Further, also in Example 3 in which the use ratio (mol %) of dimethyl 2,2′-azobis(isobutyrate) as the non-nitrile azo polymerization initiator was larger than that of Example 1 and the use ratio (mol %) of n-octylmercaptan (n-OM) as the chain transfer agent was smaller than that of Example 1, the weight reduction rate when held at 280° C. for 15 minutes was smaller and the heat retention stability was higher as compared with Comparative Example 1 in which 2,2′-azobis(2,4-dimethylvaleronitrile) as the nitrile azo polymerization initiator was used. In addition, comparing Example 3 and Example 4, in Example 4 in which an ultraviolet absorber was added, the light transmittance at a wavelength of 380 nm was smaller than that in Example 3. In addition, also in Example 5 in which the use ratio (mol %) of dimethyl 2,2′-azobis(isobutyrate) as the non-nitrile azo polymerization initiator was higher than that in Example 3 and the average polymerization temperature was higher than that in Example 3, the weight reduction rate when held at 280° C. for 15 minutes was smaller and the residence heat stability was higher as compared with Comparative Example 1 in which 2,2′-azobis(2,4-dimethylvaleronitrile) as the nitrile azo polymerization initiator was used.

In Comparative Example 2 in which polymerization was performed under the condition that the average polymerization temperature exceeded 100° C., although dimethyl 2,2′-azobis(isobutyrate) as the non-nitrile-based azo polymerization initiator was used at the use ratio (mol %) same as those in Examples 1 and 2, the weight reduction rate when held at 280° C. for 15 minutes was larger and the residence heat stability was poorer as compared with Examples 1 and 2. Further, in Comparative Example 3 in which the resin was polymerized without using the chain transfer agent, the proportion of terminal double bonds was higher than those in Examples 1 to 5, and the weight reduction rate when held at 280° C. for 15 minutes was also higher, and the residence heat stability was poorer.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A methacrylic resin comprising a structural unit derived from methyl methacrylate in a proportion of 98% by mass or more, wherein:
the methacrylic resin has a triad syndiotacticity of 55% or more,
the methacrylic resin comprises a terminal structure that is derived from a polymerization initiator and that is represented by the following formula (1), and comprises terminal double bonds, and
a proportion of the terminal double bonds to the structural unit derived from methyl methacrylate is less than 0.020 mol %, 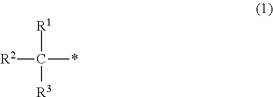
in the formula (1), R¹, R², and R³ each independently represent an alkyl group, a substituted alkyl group, an ester group, or an amide group, provided that at least one of R¹, R², or R³ represents an ester group or an amide group, two of R¹, R², or R³ may be bonded to each other to form an alicyclic structure, and * represents a bond to a structural unit derived from a monomer.

2. The methacrylic resin according to claim 1, wherein a thermogravimetric reduction ratio when exposed to 280° C. for 15 minutes in a nitrogen gas atmosphere is less than 2.5%.

3. The methacrylic resin according to claim 1, wherein the terminal structure represented by the formula (1) is a terminal structure derived from dimethyl 2,2′-azobis(isobutyrate), dimethyl 1,1′-azobis(1-cyclohexanecarboxylate) or combinations thereof.

4. The methacrylic resin according to claim 1, wherein the methacrylic resin has a weight average molecular weight (Mw) measured by gel permeation chromatography (GPC) of 50,000 to 200,000.

5. The methacrylic resin according to claim 1, wherein the methacrylic resin has a ratio (Mw/Mn) of a weight average molecular weight (Mw) to a number average molecular weight (Mn) measured by gel permeation chromatography (GPC) of 1.6 to 2.5.

6. A method for producing a methacrylic resin, comprising:
polymerizing a monomer mixture having a methyl methacrylate content of 98% by mass or more at 100° C. or less in a presence of a non-nitrile azo polymerization initiator and a chain transfer agent until a polymerization conversion ratio reaches 90% or more,
wherein:
an amount of the chain transfer agent is 0.10 mol % or more with respect to a total amount of the monomer mixture, and
a ratio of a total molar amount of the chain transfer agent to a total molar amount of the non-nitrile azo polymerization initiator is 2.0 or more.

7. The method for producing a methacrylic resin according to claim 6, wherein aqueous polymerization is performed in the polymerizing.

8. The method for producing a methacrylic resin according to claim 6, wherein the non-nitrile azo polymerization initiator comprises dimethyl 2,2′-azobis(isobutyrate), dimethyl 1,1′-azobis(1-cyclohexanecarboxylate), or combinations thereof.

9. A resin composition including the methacrylic resin according to claim 1.

10. The resin composition according to claim 9, further comprising an ultraviolet absorber.

11. A resin film comprising the methacrylic resin according to claim 1.

12. The resin film according to claim 11, further comprising an ultraviolet absorber.

13. The resin film according to claim 11, wherein the resin film is a polarizer protective film.

14. A polarizing plate formed by laminating a polarizer and the resin film according to claim 11.

15. A display device comprising the polarizing plate according to claim 14.

16. The methacrylic resin according to claim 1, wherein the triad syndiotacticity is 67% or less.

17. The methacrylic resin according to claim 1, wherein the glass transition temperature is 120° C. or higher.

18. The resin composition according to claim 9, wherein the resin composition is in a form of pellets.

19. The resin film according to claim 11, wherein the resin film is a stretched film.

20. An optical film comprising the methacrylic resin according to claim 1.
